(19) United States
(12) Patent Application Publication
(10) Pub. No.: US 2013/0034619 A1
(43) Pub. Date: Feb. 7, 2013

(54) METHOD FOR INSECTICIDAL TREATMENT OF AN ELEMENT OR OF A LIVING QUARTER

(71) Applicant: Benoit NYS, BIOT (FR)

(72) Inventor: Benoit NYS, BIOT (FR)

(73) Assignee: BREYNER, CHAPONNAY (FR)

(21) Appl. No.: 13/562,936

(22) Filed: Jul. 31, 2012

Related U.S. Application Data
(60) Provisional application No. 61/514,539, filed on Aug. 3, 2011.

(51) Int. Cl. A01N 65/44; A01P 7/02; A01P 7/04

(52) U.S. Cl. 424/739; 424/747; 424/745

(57) ABSTRACT

The invention relates to a method for insecticidal treatment of an element or of a living quarter, where the element or all or part of said living quarter is treated with a composition which includes:
a) geraniol,
b) lemongrass essential oil,
c) mint essential oil,
d) at least one essential oil selected from the group formed by geranium essential oil, thyme essential oil, lemon balm essential oil, clove essential oil and rosemary essential oil,
e) sodium lauryl sulfate,
f) and water,
   the composition being free of pyrethrinoids.

### CROSS REFERENCE TO RELATED APPLICATION

This application is related to and claims the benefit of U.S. Provisional Patent Application Ser. No. 61/514,539 filed on 3 Aug. 2011, the contents of which are hereby incorporated by reference in their entirety.

### TECHNICAL FIELD

The present invention relates to a method for insecticidal treatment of an element or a living quarter in order to combat infestation of the habitats by insects, and most particularly by bed bugs.

### BRIEF DESCRIPTION OF RELATED ART

In developed countries, the presence of insects, such as beetles, cockroaches or mites, in the habitat is assimilated to poor maintenance of the accommodation and generally contributes to the outbreak of nuisances, allergic reactions, or even to diseases. For example, acarids present in bedding may cause asthma.

Most of these insects are controlled with generally synthetic, aggressive insecticidal household products which are directly sprayed onto the insect in order to immediately kill it and which are not favorable to the environment.

Bed bugs are insects belonging to the order of Heteroptera. Provided with a buccal apparatus allowing them to bite and suck blood and, without any wings, they move by walking around. The most widely spread bed bug species is the Cimex lectularius bug.

Three stages are known in the cycle of the development of the bed bug:
the egg hatches after one to three weeks;
the nympha, identical with the adult but smaller, which, after each molt, has to feed on blood;
and finally the adult.

Complete development from the stage of the egg to that of the adult, is very variable, from six weeks to an entire year. The female may lay up to 200 eggs, up to twice a day.

Bed bugs are insects which are very well adapted to a habitat, and this even under unfavorable conditions, since they may survive for a year without any food.

Bed bugs are generally present in bedrooms. During the day, they are easily concealed in dark locations, in the mattress, in the bed base, behind skirting boards, under wallpaper, on walls behind frames, in cracks of the furniture, of the floor. And at night, they attack their host for feeding themselves with his/her blood.

Bed bugs only move over very short distances, without moving away from their host. Nevertheless they propagate from one dwelling to another, even far from each other, on the occasion of moving furniture, bedding, but also by simply transporting clothes in a suitcase.

The bites of bed bugs, depending on the subject, may only appear as small red spots without causing any other reactions, or else on the contrary, cause inflammation with pruritus. Bed bugs are not considered as disease carriers, and in spite of the annoyances caused by their presence, the extent of which is not evaluated considering their way of life, they are not really controlled in a preventive way.

Document GB 2,423,929 A describes a treatment method against bed bugs consisting of placing a textile web impregnated with a liquid based on pyrethrinoids, such as permethrin, which is intended to line bedding articles, such as curtains, wall hangings. The uses of such a web however remains very limited to textile applications. Moreover, this treatment exposes the occupant of the room to high concentrations of permethrin, for which it is known that it should be present in high proportions in order to be efficient over a sufficiently long period of time.

Document U.S. Pat. No. 5,998,484 describes an insecticidal composition of an aerosol containing a combination of active ingredients with low toxic risk and with a wide spectrum of activities. By using such a product it is possible within a reduced time to remove the insects when the product is directly sprayed on them, but it does not have any preventive potential, except if it is used in combination with a mineral oil, which is a byproduct of the distillation of petroleum, not very biodegradable and therefore not very ecological.

Therefore there exists a real need for having an insecticidal treatment method which allows treating not only one element which may be in contact with insects, in particular insects present in dwellings, but also all or part of a living quarter and which combines properties of efficiency in eradicating insects, of lack of toxicity for human beings or pets in contact with the element or present in the living quarter, while being ecological.

By insects present in dwellings, are notably meant acarids, mites, moths, varied carpet beetles, bed bugs, mosquitoes, ticks.

### BRIEF SUMMARY

The invention provides a method for insecticidal treatment of an element or of a living quarter which is characterized in that said element or all or part of said living quarter is treated with a composition which comprises:
a) geraniol,
   b) lemongrass essential oil,
   c) mint essential oil,
   d) at least one essential oil selected from the group formed by geranium essential oil, thyme essential oil, lemon balm essential oil, clove essential oil and rosemary essential oil,
   e) sodium lauryl sulfate,
   f) and water,
      said composition being free of pyrethrinoids.

Further, the composition may comprise at least one essential oil selected from the group formed by cedar essential oil, cinnamon essential oil, eugenol, garlic essential oil and peppermint essential oil.

The method for insecticidal treatment according to the invention has the advantage that all the constituents of the composition have a minimum toxic risk for human beings and pets, and are not a priori dangerous for them in the case of extended contact with the treated element or in the case of presence in the living quarter which has been treated.

Further, the inventor of the present invention realized quite surprisingly that the selection of the constituents of the composition described above was quite efficient for rapidly removing the insects detailed hereinbefore, when the element of the living quarter was treated with the composition.

The treatment of the method according to the invention may include spraying, impregnation, padding, coating or deposition of said composition on the element.

With the method for insecticidal treatment according to the invention, all or part of the dwelling may be treated by spraying or by depositing said composition.

The element may be selected from the group formed by furniture textile articles, bedding textile articles, furnishing wallpapers, floorings, wall coatings, insulators, insulating webs and wood paneling.

More specifically, these may be textile articles selected from curtains, nettings, wall coverings, as well as sheets, blankets, duvets, pillows, mattresses, eiderdowns, mattress toppers, bedding protections, bed bases but also mosquito nets, air conditioning filters.

The element may also be a material intended for manufacturing an article. These may be any textiles, either woven or non-woven, a knit, but also feathers, wools, fill fibers, mattress fabrics.

The element which is treated within the scope of the insecticidal treatment method may also be selected from floorings, such as carpets, carpetings, linoleum, felts or further insulation webs.

The coating treatment may comprise applying on the element a layer of paint, of varnish or of any other liquid for treating walls or further furniture.

The insecticidal treatment method according to the invention is applied against insects selected from the group formed by bed bugs, mites, acarids, cockroaches, moths, carpet beetles, ticks and beetles. It is most particularly advantageous against bed bugs.

In an embodiment of the invention, the composition further comprises at least one alcohol selected from the group formed by ethanol and isopropanol.

The presence of one of these alcohols in the composition contributes to fluidification of the composition and to favoring its impregnation in textile articles.

According to a preferred embodiment of the invention, the element is a textile article which is impregnated with the composition according to a weight percentage dosage based on the weight of the textile article, comprised between 2.5% and 5% and said composition comprises by weight:
from 1% to 5% of a mixture comprising geraniol, lemongrass essential oil, mint essential oil and at least one essential oil selected from the group formed by geranium essential oil, thyme essential oil, lemon balm essential oil, clove essential oil and rosemary essential oil,
from 6% to 10% of sodium lauryl sulfate,
optionally from 3% to 10% of an alcohol selected from ethanol and isopropanol,
at least 80% of water.

According to another advantageous embodiment of the invention, the element is a textile article which is impregnated with the composition according to a weight percentage dosage based on the weight of the textile article, comprised between 0.1% and 0.5% and said composition comprises by weight:
from 15% to 30% of a mixture comprising geraniol, lemon grass essential oil, mint essential oil and at least one essential oil selected from the group formed by geranium essential oil, thyme essential oil, lemon balm essential oil, clove essential oil and rosemary essential oil,
from 15% to 25% of sodium lauryl sulfate,
optionally from 15% to 25% of an alcohol selected from ethanol and isopropanol,
at least 20% of water.

### BRIEF DESCRIPTION OF THE DRAWINGS

FIG. 1 is a diagram giving details on the time in hours required for killing 100% of the bed bugs versus 8 compositions upon carrying out an efficiency test of the insecticidal properties of these 8 compositions.

FIG. 2 is a diagram giving details comparatively on the efficiency of compositions 1 and 2 versus time.

### DETAILED DESCRIPTION

Table 1 below gives the details of the contents of 8 compositions which were tested. These are weight percentages of each of the constituents of each of the compositions 1 to 8.

TABLE 1

| | Composition No. | | | | | | | |
|---|---|---|---|---|---|---|---|---|
| Ingredient (%) | 1 | 2 | 3 | 4 | 5 | 6 | 7 | 8 |
| Geraniol | 30 | 40 | 20 | 0 | 0 | 30 | 30 | 20 |
| Lemongrass EO | 0 | 0 | 0 | 0 | 0 | 0 | 20 | 30 |
| Geranium EO | 0 | 0 | 10 | 25 | 20 | 0 | 0 | 10 |
| Thyme EO | 0 | 0 | 0 | 0 | 20 | 15 | 0 | 10 |
| Lemonbalm EO | 0 | 0 | 10 | 25 | 0 | 10 | 20 | 0 |
| Rosemary EO | 20 | 0 | 20 | 0 | 20 | 0 | 0 | 0 |
| Clove EO | 0 | 0 | 0 | 0 | 20 | 15 | 10 | 0 |
| Mint EO | 50 | 60 | 40 | 50 | 20 | 30 | 20 | 30 |

EO: essential oil

The compositions 2, 4 and 6 are so called <<comparative >> compositions.

The compositions 1, 3, 5, 7 and 8 are compositions said to be <<according to the invention >>, since they comprise active constituents of the composition applied during the insecticidal treatment according to present invention.

The efficiency against bed bugs of the 8 compositions detailed in Table 1 above was measured by carrying out a test adapted from the WHO protocol, a so-called <<cone test >>, which is generally used for studying the insecticidal efficiency on mosquitoes, but which may also be applied to bed bugs.

The strain Cimex lectularius, originating from the University of Cardiff, being notoriously sensitive to the known families of insecticides (pyrethrinoids plus organo-phosphorus compounds) was used during the test. To do this, 3 batches of 25 adults were used.

The test was composed of introducing the insects into standard PVC cones. At the end of the cones is found a textile support (cotton of 150 g/m²) tilted at 40° and treated with each of the 8 aforementioned compositions. For the 4 cones, the amount of textile used was 0.25 m×0.25 m i.e. 0.0625 m².

The tests were carried out at a temperature of 25° C.±1° C., at a relative humidity of 75%±5%, in subdued light (300 lux).

As soon as the insects were introduced into the cones, the experimenter triggered a stop-watch and measured the <<KD>> (killing duration) at regular intervals. Bed bugs incapable of moving normally were considered as killed or dead.

Three repetitions of the tests were carried out in order to check the results.

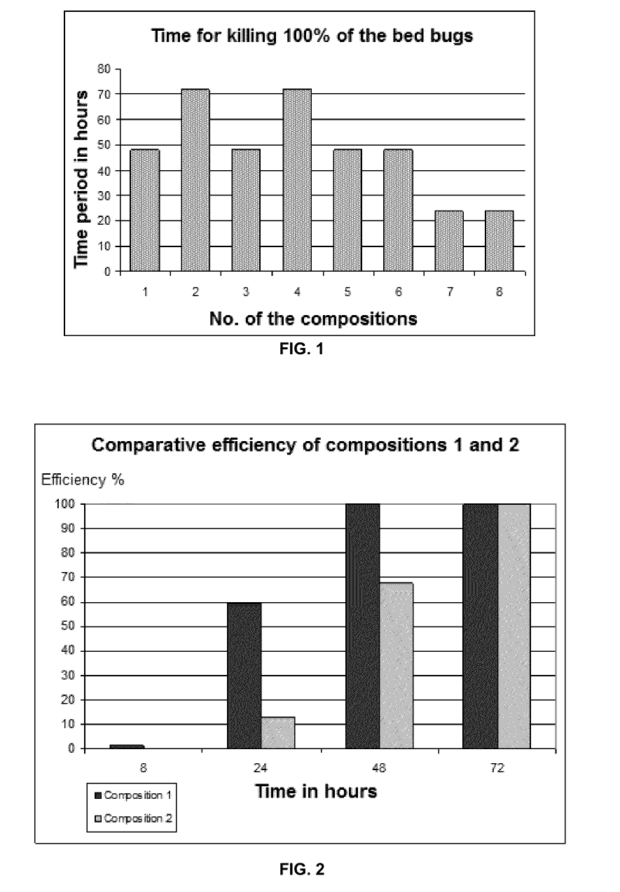

The results of this test are detailed in the diagram of FIG. 1. The diagram indicates the time in hours for killing 100% of the bed bugs. It is seen that the compositions 7 and 8 according to the invention are the most efficient, since the total killing time of the bed bugs (of the order of 22 hours) is much less than that of the comparative compositions 2, 4 and 6 which may spread out between 48 and 71 hours.

The diagram of FIG. 2 comparatively details versus time, the efficiency of the compositions 1 and 2 detailed above in Table 1 for killing bed bugs. It is found that composition 1 (according to the invention) is efficient much more rapidly than composition 2 (a so-called comparative composition).

The following tests were conducted. 8 tests were prepared, in which the weight percentage of the composition 7 of Table 1 above was 2.5%, and sodium lauryl sulfate was added to the percentage indicated in Table 2 hereafter and was completed to 100% with water.

TABLE 2

| | Tests No. | | | | | | | | | |
|---|---|---|---|---|---|---|---|---|---|---|
| | 1 | 2 | 3 | 4 | 5 | 6 | 7 | 8 | 9 | 10 |
| Sodium lauryl | 2.5 | 4.0 | 5.0 | 5.5 | 6.0 | 6.5 | 7.0 | 7.5 | 8.5 | 10 |
| sulfate (%) | | | | | | | | | | |

| | | | |
|---|---|---|---|
| Stability of the | Phase- | Cloudiness | Limpid |
| composition | separation | | |

According to Table 2, it is seen that the composition is stable when the sodium lauryl sulfate percentage is comprised between 6.5 and 10%.

During another experiment, both of the following compositions A′ and B′ were prepared (weight percentages are indicated):

Composition A′: 2.5% of the composition No. 7 described in the table above, 7.5% of sodium lauryl sulfate, 5% of isopropanol and 85% of water.

Composition B′: 2.5% of composition No. 8 described in the table above, 7.5% of sodium lauryl sulfate, 5% of isopropanol and 85% of water.

The compositions A′ and B′ were applied according to the following dosages on a textile (cotton of 150 g/m²): 10%, 5% and 2.5%.

In other words, the question was of depositing 10 g, 5 g and 2.5 g of the aforementioned compositions on 100 g of textile to be treated.

To do this, the compositions A′ and B′ were each diluted in a water bath according to the amount of water that the textile carries away (carrying-away rate) and then acidified in order to increase their affinity with the textile. The textile is then soaked in each of the baths of acidified water, and is then expressed between two rollers, so as to remove the excess water.

Next, the textile was dried, so as to set the active constituents of the compositions A′ and B′ in the textile while releasing the acidified water used for putting them into solution.

Table 3 below details the obtained results relating to the ease of application and the efficiency against bed bugs according to the dosages of the compositions A′ and B′ on the textile to be treated.

TABLE 3

| | Composition A′ | | | Composition B′ | | |
|---|---|---|---|---|---|---|
| Dosage (%) | 10 | 5 | 2.5 | 10 | 5 | 2.5 |
| Ease of Application | − | + | ++ | − | + | ++ |
| Efficiency against bed bugs | ++ | ++ | + | + | ∘ | ∘ |

++ = excellent
+ = good
∘ = average
− = poor

According to Table 3, it is seen that the best treatment efficiency is obtained when the dosage of the composition according to the invention by weight is comprised between 2.5 and 5% based on the weight of the textile to be treated.

TABLE 4

| | | | | | | | | | | | stan- |
|---|---|---|---|---|---|---|---|---|---|---|---|
| | rep 1 | | | rep 2 | | | rep 3 | | | | dard |
| | | | % | | | % | | | % | aver- | devi- |
| | M | V | KD | M | V | KD | M | V | KD | age | ation |
| 24 h | 13 | 12 | 52 | 17 | 8 | 68 | 19 | 6 | 76 | 65 | 12 |
| 48 h | 25 | 0 | 100 | 25 | 0 | 100 | 25 | 0 | 100 | 100 | 0 |
| 72 h | 25 | 0 | 100 | 25 | 0 | 100 | 25 | 0 | 100 | 100 | 0 |

M = dead or killed
V = alive
% KD = killing % or mortality %
rep = repetition

Table 4 indicates the efficiency of the treatment versus time against bed bugs Cimex lectualrius obtained with composition A′ on 100% cotton textile.

TABLE 5

| | | | | | | | | | | | stan- |
|---|---|---|---|---|---|---|---|---|---|---|---|
| | rep 1 | | | rep 2 | | | rep 3 | | | | dard |
| | | | % | | | % | | | % | aver- | devi- |
| | M | V | KD | M | V | KD | M | V | KD | age | ation |
| 24 h | 0 | 25 | 0 | 0 | 25 | 0 | 0 | 25 | 0 | 0 | 0 |
| 48 h | 0 | 25 | 0 | 0 | 25 | 0 | 0 | 25 | 0 | 0 | 0 |
| 72 h | 0 | 25 | 0 | 0 | 25 | 0 | 1 | 24 | 4 | 1 | 2.3 |

Table 5, as a comparison, indicates the results obtained with the same tests when the textile was not treated with the composition A′ according to the invention.

TABLE 6

| Duration of | | | | | |
|---|---|---|---|---|---|
| the test | After 8 days | | | After 6 weeks | |
| repetition | M | V | % M | V | % reduction |
| 1 | 41 | 10 | 80.4 | 0 | 100 |
| 2 | 38 | 11 | 77.6 | 0 | 100 |
| avg. | | 10.5 | 79.0 | 0 | 100 |
| standard | | | 2.0 | | 0 |
| deviation | | | | | |

M = dead
V = alive
% M = mortality %

Table 6 indicates the efficiency of the treatment against acarids, Dermatophagoides Pteronyssinus, obtained with the composition A′ on 100% cotton textile.

TABLE 7

| Duration of | | | | | |
|---|---|---|---|---|---|
| the test | After 8 days | | | After 6 weeks | |
| repetition | M | V | % M | V | % reduction |
| 1 | 1 | 53 | 1.9 | 925 | — |
| 2 | 1 | 48 | 2.0 | 914 | — |
| avg. | | 50.5 | 1.9 | 919.5 | — |
| standard | | | 0.1 | 7.8 | — |
| deviation | | | | | |

Table 7, as a comparison, indicates the results obtained with the same test when the textile was not treated with the composition A′ according to the invention.

TABLE 8
EFFECT ON LARVAE

| | rep 1 | | | rep 2 | | | rep 3 | | | |
|---|---|---|---|---|---|---|---|---|---|---|
| | M | V | % M | M | V | % M | M | V | % M | average |
| 24 h | 25 | 0 | 100 | 25 | 0 | 100 | 25 | 0 | 100 | 100 |
| 48 h | 25 | 0 | 100 | 25 | 0 | 100 | 25 | 0 | 100 | 100 |

No molting into adult
Table 8 indicates the efficiency of the treatment against larvae of Tineola Bisselliella mites obtained with the composition A′ according to the invention.

TABLE 9
EFFECT ON EGGS

| | rep 1 | | | rep 2 | | | rep 3 | | | |
|---|---|---|---|---|---|---|---|---|---|---|
| | M | V | % M | M | V | % M | M | V | % M | average |
| 24 h | 20 | 0 | 100 | 20 | 0 | 100 | 20 | 0 | 100 | 100 |
| 48 h | 20 | 0 | 100 | 20 | 0 | 100 | 20 | 0 | 100 | 100 |

No hatching
Table 9 indicates the efficiency of the treatment against eggs of mites Tineola Bisselliella obtained with the composition A′ according to the invention.

TABLE 10
EFFECT ON ADULTS

| | rep 1 | | | rep 2 | | | rep 3 | | | |
|---|---|---|---|---|---|---|---|---|---|---|
| | M | V | % M | M | V | % M | M | V | % M | average |
| 24 h | 25 | 0 | 100 | 25 | 0 | 100 | 25 | 0 | 100 | 100 |
| 48 h | 25 | 0 | 100 | 25 | 0 | 100 | 25 | 0 | 100 | 100 |

Number of eggs or larvae visible after 3 weeks: 0 on the 3 repetitions
Table 10 indicates the efficiency of the treatment against adult mites of Tineola Bisselliella obtained with the composition A′ according to the invention.

1. A method for insecticidal treatment of an element or a living quarter, wherein said element or all or part of said living quarter is treated with a composition which comprises:
a) geraniol,
b) lemongrass essential oil,
c) mint essential oil,
d) at least one essential oil selected from the group formed by geranium essential oil, thyme essential oil, lemon balm essential oil, clove essential oil and rosemary essential oil,
e) sodium lauryl sulfate,
f) water,
said composition being free of pyrethrinoids.

2. The insecticidal treatment method according to claim 1, wherein the composition further comprises at least one essential oil selected from the group formed by cedar essential oil, cinnamon essential oil, eugenol, garlic essential oil and peppermint essential oil.

3. The insecticidal treatment method according to claim 1, wherein the element is treated by spraying, impregnation, padding, deposition or coating of said composition.

4. The insecticidal method according to claim 1, wherein all or part of the living quarter is treated by spraying or coating said composition.

5. The insecticidal treatment method according to claim 1, wherein the element is selected from the group formed by furniture textile articles, bedding textile articles, floorings, wall claddings, furnishing wallpapers, insulators, insulating webs and wood paneling.

6. The treatment method according to claim 1, wherein the insects are selected from the group formed by bed bugs, mites, acarids, cockroaches, ticks, moths, carpet beetles and beetles.

7. The insecticidal treatment method according to claim 6, wherein the insect is a bed bug.

8. The insecticidal treatment method according to claim 1, wherein the composition further comprises at least one alcohol selected from the group formed by ethanol and isopropanol.

9. The insecticidal treatment method according to claim 1, wherein the element is a textile element which is impregnated with the composition according to a percentage dosage by weight based on the weight of the textile article comprised between 2.5% and 5% and that the composition comprises by weight:
from 1% to 5% of a mixture comprising geraniol, lemongrass essential oil, mint essential oil and at least one essential oil selected from the group formed by geranium essential oil, thyme essential oil, lemon balm essential oil, clove essential oil and rosemary essential oil,
from 6% to 10% of sodium lauryl sulfate,
optionally from 3% to 10% of an alcohol selected from ethanol and isopropanol,
at least 80% of water.

10. The insecticidal treatment method according to claim 1, wherein the element is a textile article which is impregnated with the composition according to a percentage dosage by weight based on the weight of the textile article comprised between 0.1% and 0.5% and that the composition comprises by weight:
from 15% to 30% of a mixture comprising geraniol, lemongrass essential oil, mint essential oil and of at least one essential oil selected from the group formed by geranium essential oil, thyme essential oil, lemon balm essential oil, clove essential oil and rosemary essential oil,
from 15% to 25% of sodium lauryl sulfate,
optionally from 15% to 25% of an alcohol selected from ethanol and isopropanol,
at least 20% of water.
